(19) United States
(12) Patent Application Publication
(10) Pub. No.: US 2013/0224694 A1
(43) Pub. Date: Aug. 29, 2013

(54) Integrated System and Method for Meal Planning and Management

(71) Applicants: Laura M. Moore, Lutherville, MD (US); Charles P. Moore, Lutherville, MD (US)

(72) Inventors: Laura M. Moore, Lutherville, MD (US); Charles P. Moore, Lutherville, MD (US)

(21) Appl. No.: 13/595,997

(22) Filed: Aug. 27, 2012

Related U.S. Application Data
(60) Provisional application No. 61/527,696, filed on Aug. 26, 2011.

(51) Int. Cl. G09B 19/00

(52) U.S. Cl. CPC G09B 19/0092
USPC 434/127

(57) ABSTRACT

A computer implemented system and method For familial meal-planning decision support by analyzing user pre-defined inputs of constraints and priorities, reflecting their individual family size, nutritional concerns, tastes, as well as the user's constraints on time, budget, interest in experimentation, and variety, store preferences, etc. The software engine maps the user-defined inputs against local store sales, promotions, and/or manufacturer offers, and compiles a suggested periodic meal and shopping plan and, if accepted, shopping list by store organized by aisle or delivery order). The system is customizable and employs artificial intelligence to learn from user feedback and scoring as well as comparisons to other similar families

### CROSS-REFERENCE TO RELATED APPLICATIONS

The present application derives priority from U.S. provisional application Ser. No. 61/527,696 filed: Aug. 26, 2011.

### BACKGROUND OF THE INVENTION

1. Field of the Invention

The present invention relates generally to meal and food planning and, more particularly, to a meal planning system, and related method, for generating customized meal plans that take advantage of localized food cost information and promotions.

2. Description of the Background

Cultural changes over the past decade have resulted in increased numbers of families with two adults working outside the home, more structured and scheduled activities for school aged children, and generally increased pressure on family schedules and time. Nevertheless, families recognize the value of sharing an evening meal together in the home and all the social, economic and health benefits that accompany it. Home prepared meals are typically less expensive and more nutritious than restaurant prepared or take-out meals, and meals at home are positively correlated to children's self esteem and performance in school and inversely correlated to drug and alcohol use and other behavioral problems, yet there has been a decades-long trend of increasing meal expenditures outside the home and a concurrent dramatic rise in childhood obesity, heart risk, and other nutrition related health costs. Currently, as much, as 45% of a typical family's food budget is spent on commercially-prepared meals, up from 25% just 30 years ago. Not coincidentally, a child born in 2000 or later now has a 1 in 3 chance of developing Type II diabetes.

These trends are a result of the simple fact that it takes a significant amount of time and energy to plan, shop for and prepare appealing nutritious meals in an economical manner at home, and family schedules are already too compressed. The complexity of meal planning is a function of the wide variety of factors that must be considered including such things as family dietary constraints and health objectives, food preferences for each member of the family (both likes and dislikes), and available preparation/pre-preparation and cooking times. Other factors to be considered are seasonal availability of particular ingredients and costs of ingredients including grocery sales, promotions and specials, plus manufacturer and retailer coupons and discounts, both generally available and locally at the store or stores where the individual shops. While information is available from myriad disparate sources, it is often confusing, technical, and formatted in ways that are difficult to make ready comparisons and decisions; thus consumers are often simply overwhelmed by the task, of planning, shopping and preparing meals at home and As a result, they often sacrifice key family priorities of cost, nutrition, and quality in the interest of convenience.

What is needed is a readily-accessible, simple to use online solution for facilitating the compilation of customized and individualized meal plans automatically tailored to meet the specific needs of an individual or family, which solicits preferences of the individual family members as well as nutritional goals and requirements, and compiles comprehensive meal plans, shopping lists and recipes, plus cost-saving assistance at the local grocery store level, all customized to the individual and/or family.

### SUMMARY OF THE INVENTION

It is, therefore, an object of the present invention to provide an integrated system and method for developing customized and individualized meal plans tailored to meet the specific needs of the family taking into account such things as the preferences of the individual family members as well as nutritional goals and requirements.

It is another object of the present invention to provide an integrated system and method that incorporates local grocer and manufacturer food product cost/promotions and inventory/availability information into the meal planning solution.

It is yet another object of the present invention to provide detailed food shopping list by store and potentially in an aisle by aisle or slot by slot basis to speed food shopping and promote adherence to the meal plan.

And it is another object of the present invention to provide a system and method for meal planning having an intelligent algorithm capable of learning familial habits and preferences and accounting for such likes and preferences in meal planning and selection.

According to the present invention, the above-described and other objects are accomplished, by a computer solution inclusive of a distributed web-enabled client-server hardware architecture and a unique software engine and method that provide meal-planning decision support by analyzing user pre-defined inputs of constraints and priorities, reflecting their individual family size, nutritional concerns, tastes, as well as the user's constraints on time, budget, interest in experimentation, and variety, store preferences, etc. The software engine maps those user-defined inputs against local store sales, promotions, and/or manufacturer offers, and compiles a suggested weekly (or other desired period) meal and shopping plan (e.g. shopping list by store organized by aisle or delivery order) and multiple meal alternatives, if desired. The system is highly flexible and customizable, and employs artificial intelligence to automatically learn from user feedback and scoring, as well as comparisons to other families with similar profiles. This provides a uniquely customer-intimate experience, while being simple to set-up, maintain, and use daily.

In sum, the present system helps consumers to manage all of their meal tasks, including meal selection, grocery shopping, prepping, and preparing in the manner that best suits the individual and/or family constraints on time, money, and nutritional concerns, as well as its personal tastes and desire for experimentation. The short term result is a marked reduction of the daily stress and strain of deciding what is for dinner, bringing a long term result that more families will share more evening meals together at home and maintain better compliance with their consciously chosen health, budget and other objectives.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which;

FIG. 1 is system architecture diagram.

FIG. 2 is logical flow chart of the meal planning and selection process.

FIG. 3 is a screen print of an exemplary member-profile data entry screen.

FIG. 4 is a screen print of an exemplary Meal Planner data entry screen.

FIG. 5 is a screen print of an exemplary date range selection screen.

FIG. 6 is a screen print of an exemplary Meal Planning screen as in FIG. 3 populated with a suggested meal plan over the date range selected in FIG. 5

### DETAILED DESCRIPTION OF THE PREFERRED EMBODIMENT

Reference will now be made in detail to preferred embodiments of the present invention, examples of which are illustrated in the accompanying drawings. Wherever possible, the same reference numbers will be used throughout the drawings to refer to the same or like parts.

Hereinafter, a virtual web-based computing system is described in which users are provided with an integrated meal planning and management system built atop a particular network database hierarchy, graphical user interface, and integrated suite of computational tools accessible on demand, by which said users can indicate familial preferences and requirements, generate, modify and accept a meal plan, produce a location specific shopping list or place a delivery order, and receive a series of cues, reminders and requests for feedback in order to carry out their meal plan.

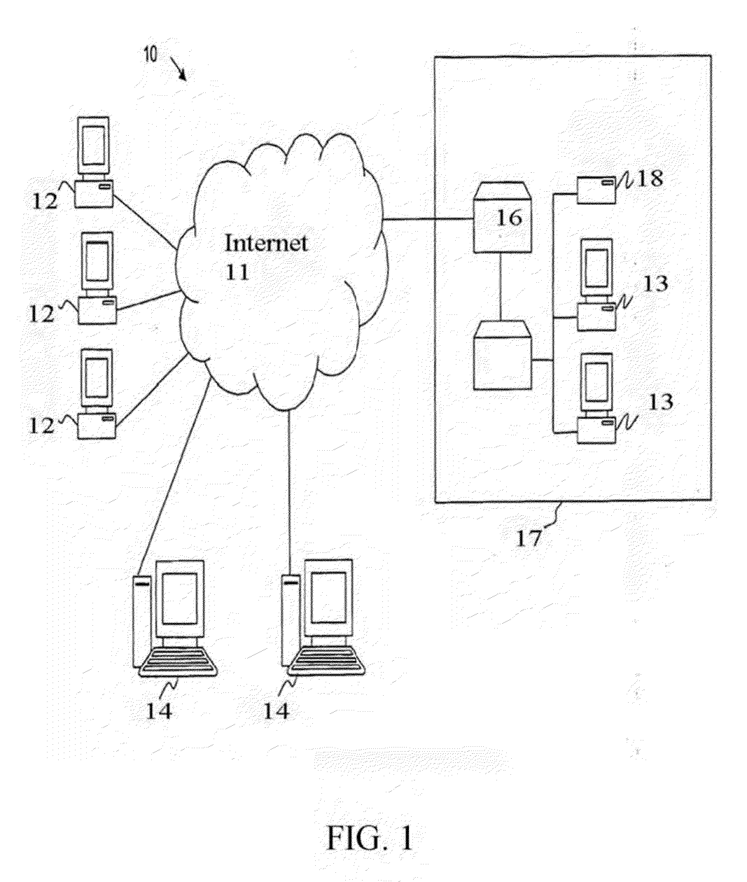

The present invention is implemented in a hosted client-server network to facilitate user-registration and subscription and maintenance of the system for a particular family/user. As shown in FIG. 1, client-server network 10 may include a plurality of clients 12, web servers 13 and database servers 18 connected via the Internet 11, Any number of clients 12 may participate in such a network 10. The system further includes at least one host service provider 17 for operating and maintaining the web and database servers and allowing administration of the system by administrators. The Internet, or World Wide Web provides a known system for interconnecting clients 12 and servers 13, 18 in a communicating relationship. Also connected via the Internet 11 are servers 14 for one or more sponsors such as food manufacturers or grocers. Said sponsors may upload current information to servers 14, such as food item costs and inventory, local promotions and discounts, and coupon data and/or to web and database servers 13, 18 for use in providing the present meal planning service to users via clients 12. Although the Internet is a preferred communications network, one or more other networks may be used such as satellite networks, the Public Switched Telephone Network, Wifi networks, WiMax networks, cellular networks, and any other public, private, or dedicated networks that might be used to interconnect devices for transfer of data. Although FIG. 1 depicts all clients 12 and sponsor servers 14 as communicating on a single network, certain embodiments will use one or more separate communications networks for client, server and/or other system nodes to facilitate implementation of the present method.

An exemplary client 12 may include a processor, a memory (e.g. RAM), a bus which couples the processor and the memory, a mass storage device (e.g. a magnetic hard disk or an optical storage disk) coupled to the processor and the memory through an I/O controller, and a network interface coupled to the processor and the memory, such as a modem, digital subscriber line (“DSL,”) card, cable modem, network interface card, wireless network card, or other interface device capable of wired, fiber optic, or wireless data communications. One example of such a client 12 is a personal computer equipped with an operating system such as Microsoft Windows, UNIX, or Linux, along with software support for Internet communication protocols. The client 12 may include at least one browser program, such as Microsoft Internet Explorer, Google Chrome™, Netscape Navigator™, Firefox™ for access to the general Internet 10 or other application to provide a user interface. Users will typically access the system via a client 12, and a typical client 12 may be a conventional web-enabled personal computer in the home, mobile computer (laptop, notebook or subnotebook), Smart Phone (iPhone, Android), VOIP device, television set-top box, interactive kiosk, personal digital assistant, wireless electronic mail device, tablet computer or other device capable of communicating over the Internet or other appropriate communications network.

Host service provider 17 includes a plurality of web servers 13 (or other content servers) which deliver the meal planning an management system by transmitting web pages (or other appropriately formatted content in view of the particular client 12 employed by the user) in (for example) hypertext markup language (HTML) or extensible markup language (XML) (or a similar scheme) using, again for example, the hypertext transport protocol (http) to any of clients 12. One or more database servers 18 running database management software to provide database services to web servers 13 and ultimately to clients 12, as defined by the client-server model. Database management, systems frequently provide database server functionality, and some DBMSs (e.g., MySQL) rely exclusively on the client-server model, for database access. Thus, server 18 preferably hosts a network database preferably an SQL server database, running MySQL. Other examples of Database servers are Oracle, DB2, Informix, Ingres, SQL Server. Secure communication lines are used between clients 12, servers 13 and ASP LAN 17 so that private data remains so.

Such servers may further include one or more mass storage devices such as a disk farm or a redundant array of independent disk (“RAID”) system for additional storage and data integrity. Suitable servers and mass storage devices are manufactured by, for example, Compaq®, IBM®, and Sun Microsystems®. Servers 13 typically run an enterprise operating system such as Sun®, Oracle Solaris® or the like, and uses a standard HTTP server, such as Apache®.

The host service provider 17 is preferably connected to the internet 11 through a secure gateway 16, which provides security to the host service provider 17 and ensures operating compatibility between the host 17 and the internet 11. The secure gateway 16 may be a Citrix Access Gateway® for securing the delivery of the system and populating data to user clients 12 and to servers 14, and which provides security to the host 17 and ensures operating compatibility between the host 17 and the internet 11. One skilled in the art will recognize that while the World Wide Web and the HTTP protocol is a currently common and popular means of communication via the Internet or other internets, the system and method of the present invention is free from the any requirement that a particular network or communications protocol be implemented and the system and method my be ported to or otherwise extended to utilize any future communications infrastructure and means as may become beneficially available. Given the foregoing architecture, for purposes of explanation the following terms are herein used to describe system operation.

Member: a person or family that has registered to use the system of the present invention. Also referred to as a user. A user may have one or more profiles associated just as a family includes one or more individuals.

User Account: a compilation of user personal information and login credentials.

User Profile: a compilation of user preferences held in an anonymized fashion.

Recipe: the complete set of ingredients and instructions required to prepare a dish.

Dish: a component of a meal (entrees, sides, etc.).

Meal: one or more dishes to be served at a particular sitting.

Meal Plan: the set of meals to be prepared in a determined period of time, typically a week.

Shopping List: a recitation of the ingredients required to be purchased in order to prepare each recipe for each meal in a meal plan.

Manufacturer: an organization that manufactures products sold under a brand.

Brand: a label under which a product is marketed or sold.

Retailer: an organization operating one or more stores.

Store/Location: a particular retail outlet.

In-Network Retailer: a grocer other retailer participating in the system of the present invention, typically providing product inventory and location information. Possibly providing member purchasing information collected via retailer rewards programs (such as in-store savings cards).

Out-Of-Network Retailer: a grocer other retailer not participating in the system of the present invention, typically providing no information. Product location information may be manually collected.

Ingredient: a food item required for preparation of a recipe.

Product: a discrete grocery item, typically having a UPC.

### System Overview:

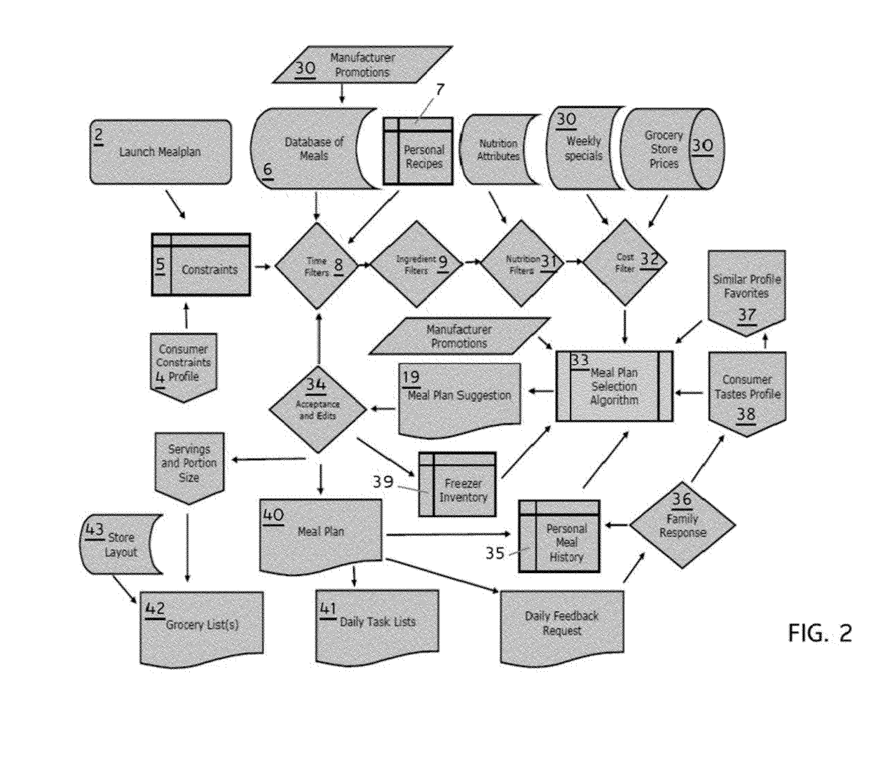

With reference to FIG. 2, a schematic diagram of the present invention is provided. Prior to launching the meal planning system and method at step 2, a member will have created a user account and populated at least one user profile. User account creation preferably requires entry of a user name, password, contact email address, physical residential address and other personal information. User profile creation requires at least a minimum level of data entry relating to the needs and preferences of one or more members of the family in order for the system to operate. Preferably, a profile is created for each member of the user family. Such information may preferably include dietary restrictions, budgetary restrictions, ingredient likes and dislikes, etc. and defines the constraints 5 placed on the system with respect to meal selection. Meal constraints are preferably predefined for anticipated situations by creating one or more meal profiles associated with the user family.

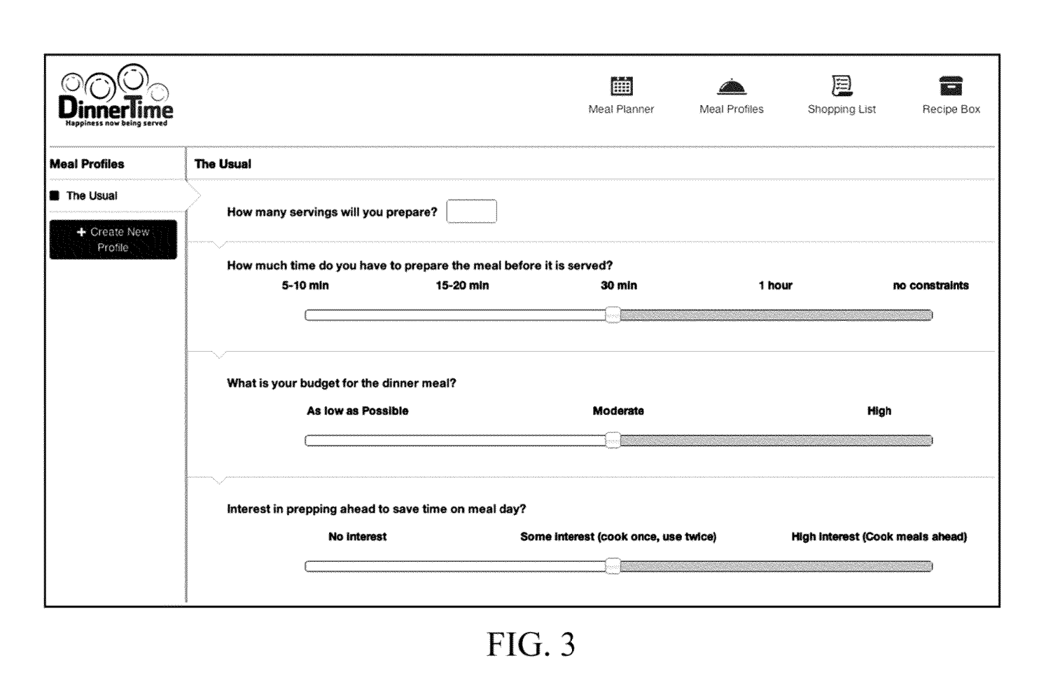

FIG. 3 is a screen print of an exemplary meal profile data entry screen by which a member can create a new profile and enter data relating to the needs and preferences of a member and/or the member's family for a given meal situation. The member can name the profile (e.g., “Usual”) and scroll down through an array of data entry fields populating the number of servings to prepare for the usual meal, the time the member has to prepare the meal before it is served, the cost budget for the meal, level of interest in preparing ahead to save time on meal day, etc. Note that for weighting purposes scalar decisions are preferably entered via sliding scale data entry toolbars. Each member can create multiple personalized meal profiles to accommodate day-to-day variability in meal planning, each profile representing a set of constraints and preferences associated with preparation of an arbitrary meal.

User profile information can be revised, updated or appended at any point to account for changing tastes and requirements. User account data and profile data are related but maintained separately so that personally identifiable information is isolated and account profile data can be used in an anonymized fashion for the benefit of members, retailers and manufacturers.

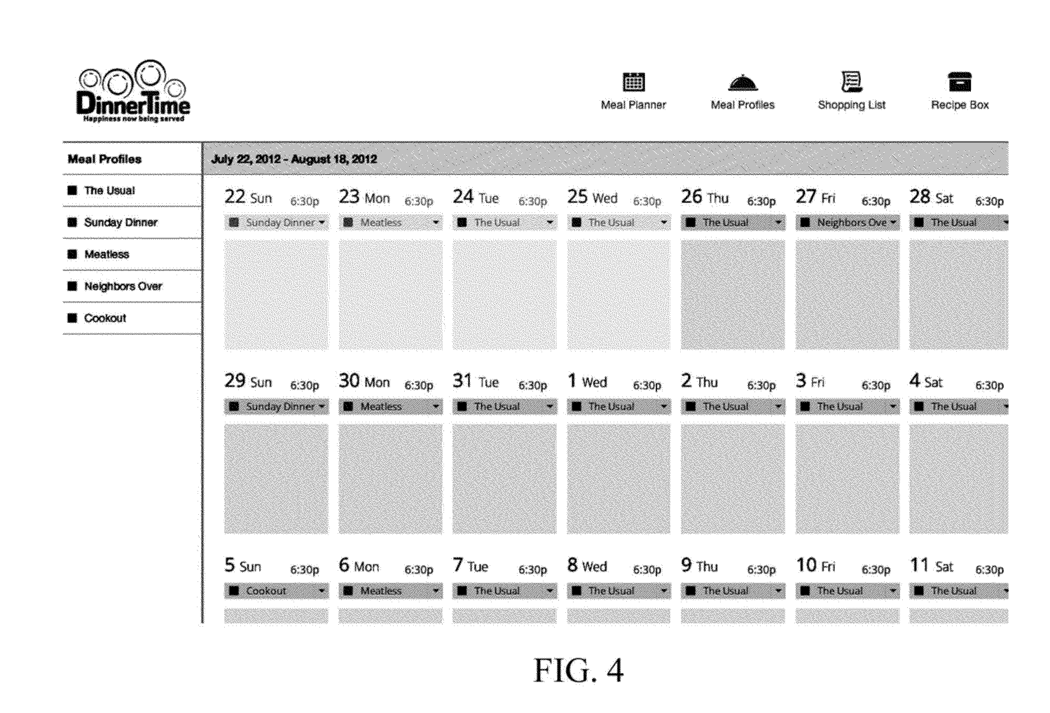

The system includes a Meal Planner, which is a user data-entry calendar that facilitates day-to-day scheduling of meals using the previously-entered member profiles. FIG. 4 is a screen print of an exemplary Meal Planner data entry screen by which a member can assign their meal profiles to each day of the week, in a monthly calendar format. The meal profiles are shown at right (e.g., the Usual, Meatless, Sunday Dinner, Cookout, Neighbors Over, etc.). By drag-and-drop, the member can allocate a color-coded profile to each calendar day, and the meal plan schedule appears as shown with profiles assigned to calendar days. The member is free to edit and rearrange their planning preferences.

Again referring to FIG. 2, after creation of account and user profiles, and a user schedule, a system-provided database of recipes/dishes 6 is loaded along with any user specific personal dishes 7 for which recipes have been entered into the system. Recipes 6 are pre-stored in the system. Each Recipe 6 includes an array of recipe ingredient entries, including reference to the associated ingredient, quantity information (measure and measure amount) and preparation information. Nutrient, allergen and price data points for recipes are computed by summing data points from the recipe's constituent ingredients and the products that comprise those ingredients. Recipes also contain a number of data points set for the recipe as a whole which may include pre-computed baseline nutrition and cost information based on baseline cost figures.

The system-provided database 6 may be populated with recipes from any of a variety of publicly available recipe sources as well as by food manufacturers who may provide recipes designed to take advantage of promotions and specials 30 for their products. A series of filters is applied to the library of dishes to identify dish candidates for inclusion in the meal plan to be generated. Dish candidates are filtered for available preparation and cooking time 8, required or banished ingredients 9, nutritional requirements 31 and cost requirements 32. The nutritional characteristics of each dish are stored and used when applying nutritional filters 31 to the dish library.

Similarly, prices for grocery items including periodic (e.g., weekly, etc.) specials 30 and coupons uploaded by sponsors to servers 13, 14 or 18 are stored and used to apply cost filters 32 to a dish or meal based on the stored recipe for each dish along with serving number and size information.

In addition, the system tracks user history information. The history is provided in the form of art array of recipes the user has interacted with in the past. A user-history of data points about each recipe is accumulated, including number of times a recipe has been suggested and accepted or confirmed by the user, when the recipe was most recently served, the number of times a recipe has been suggested and rejected by the user, when the recipe was most recently suggested and rejected/not confirmed, and user ratings for each recipe.

A meal selection plan algorithm 33 (as will be discussed below) is then applied to the filtered database of dishes to generate a suggested meal plan 19 which is presented to the user for review and modification 34.

Among the factors considered in the meal selection algorithm is the family's meal history over time (meal history data points per above) 35, feedback from family members on previously suggested and served meals 36, the feedback from other, similarly profiled users 37 and consumer taste profiles 38 as well as and the availability of previously prepared and stored dishes or ingredients 39. The user can re-order or replace suggested meals or can modify the profile parameters during the modification and confirmation/acceptance step 34 and re-run the constraint filters 8, 9, 31, 32 and meal selection algorithm 33 to generate a revised meal plan suggestion 19.

Weighted factors considered by the meal plan selection algorithm 12 include:
family health concerns, dietary restrictions;
family budget;
food preparation and cooking times (both immediate and in advance);
season/holidays/religious cycles;
appliance availability (e.g. slow cooker, grill, etc.);
avoiding duplication of recent meals;
family's meal preferences/ratings;
family's portions, servings;
meals that have been positively profiled by “similar” families;
desire for new tastes, cooking experiences,
what's on sale in local (preferred) stores;
the total number of stores to shop for needed ingredients; and
paid advertising by sponsors and other product promotional support.

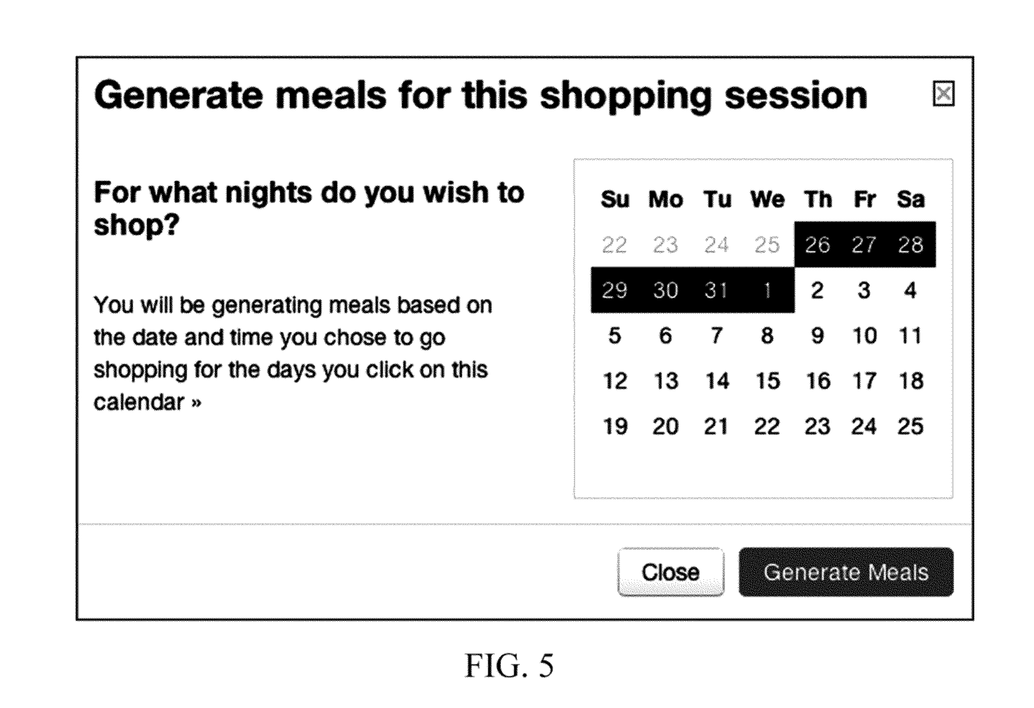

Once the user/member has completed the user and meal profile and preference setup stage, the user is free to come sign on to the system and select a date range over which to to generate a meal plan. FIG. 5 is a screen print of an exemplary date range selection screen. The member simply selects a desired date range. The meal selection algorithm 33 will generate a suggested meal plan, over the selected range, and, after confirming the plan with the user, generate an associated shopping list. The meal selection plan algorithm 33 evaluates the data points available from the member profile, schedule, recipes from the filtered database of dishes, user history, filtered prices for grocery items including weekly specials 30 and coupons, and generates a suggested meal plan 19 which is presented to the user for review and modification 34.

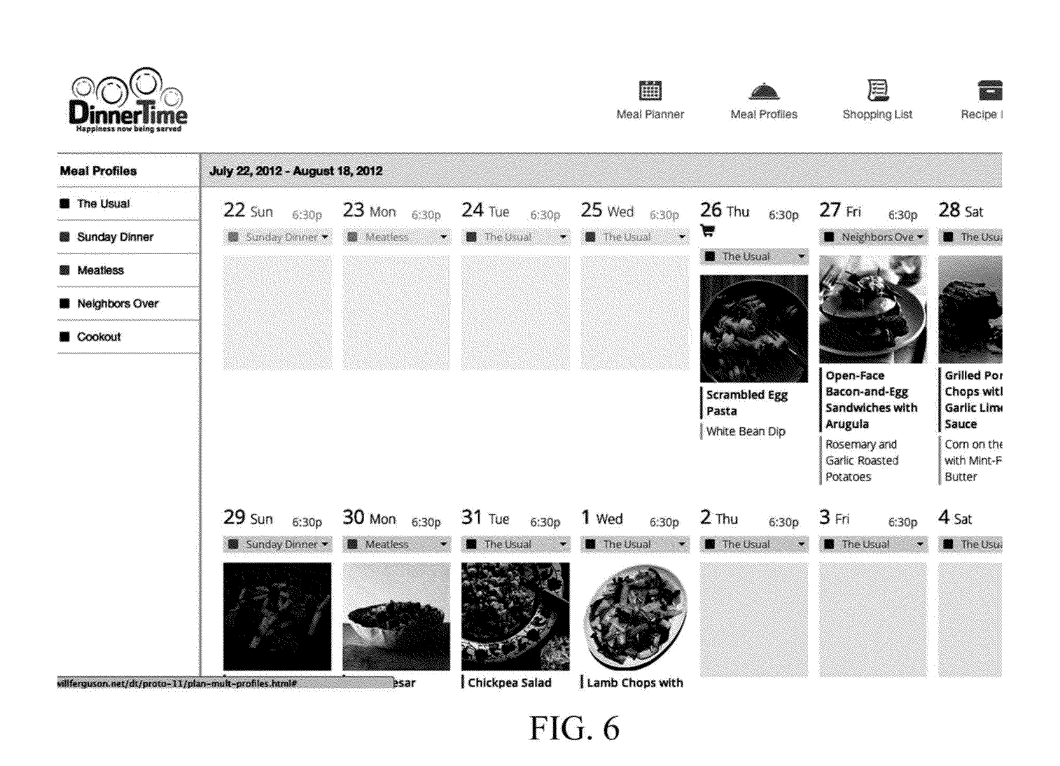

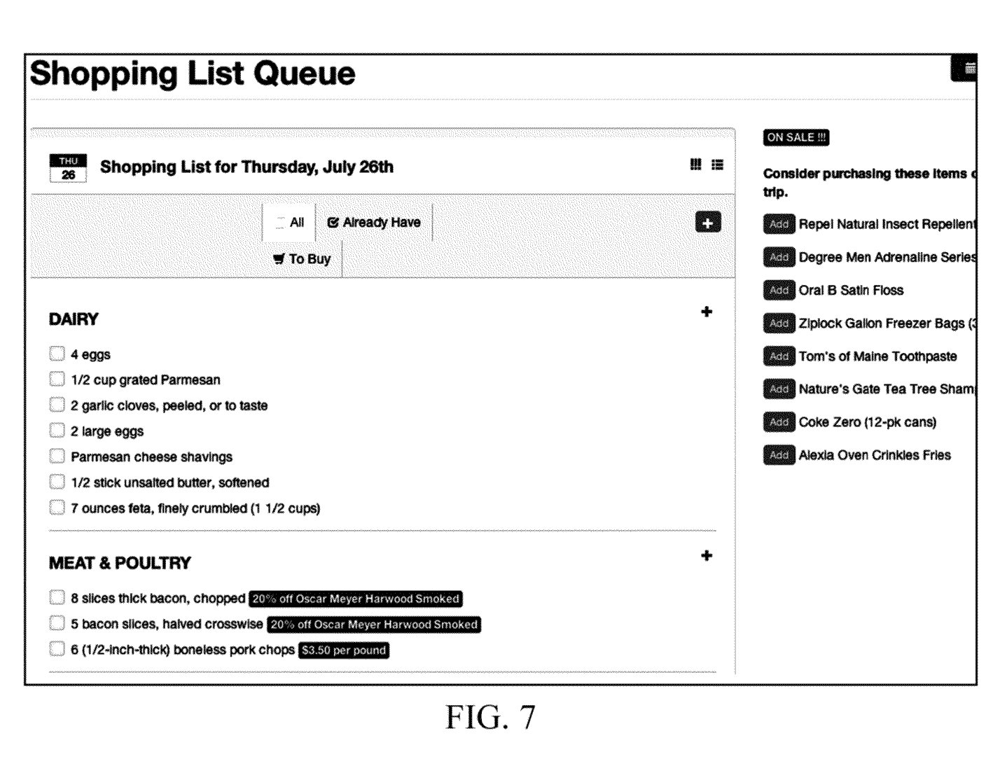

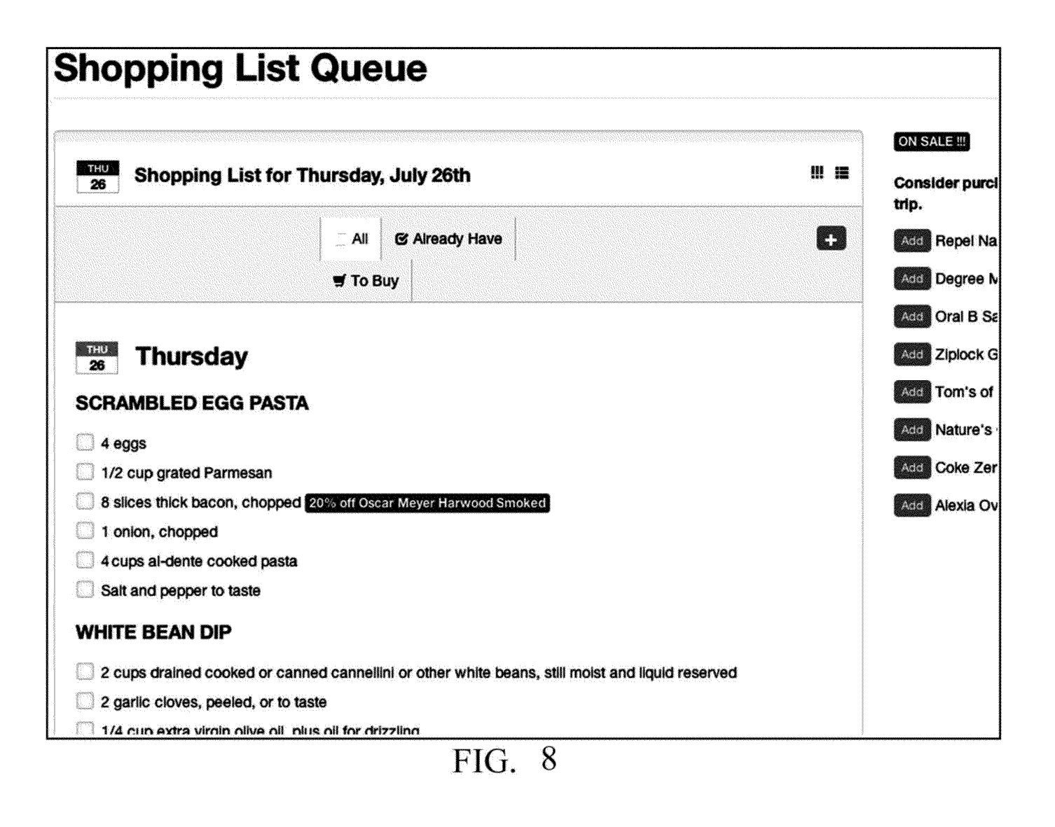

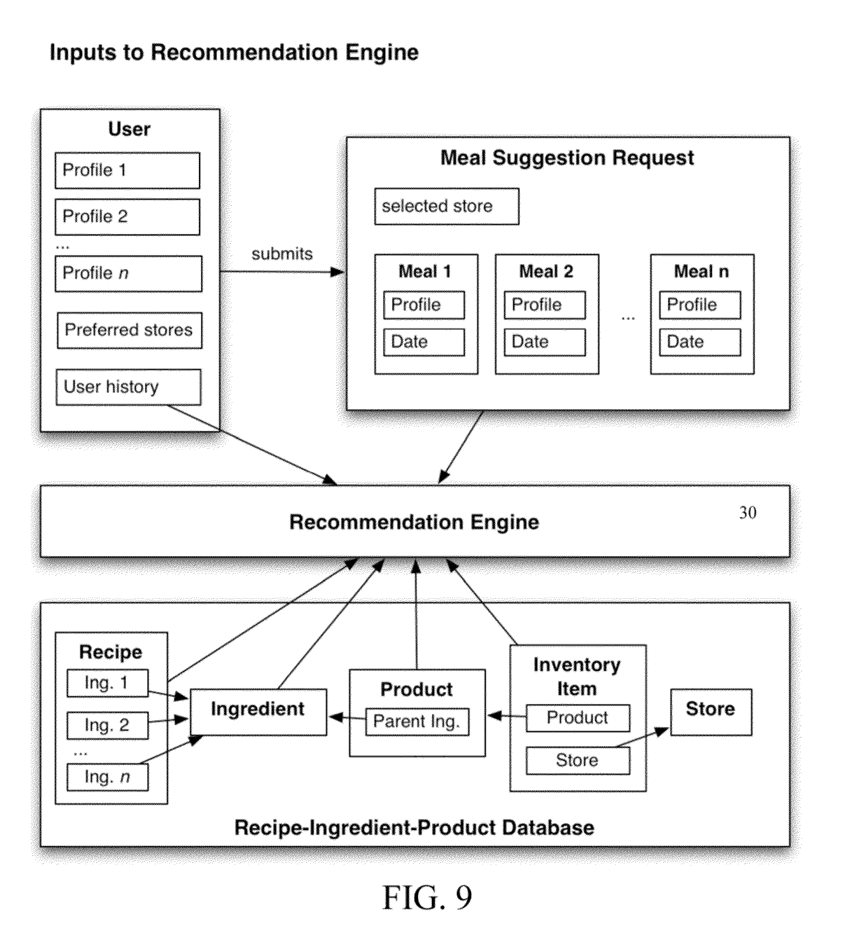

The suggested meal plan 19 may be presented to the user graphically by populating the Meal Planning screen of FIG. 3. FIG. 6 is a screen print of an exemplary Meal Planning screen as in FIG. 3 but populated with a suggested meal plan 19 over the date range selected in FIG. 5. Each proposed recipe selected in accordance with the member profile assigned to each day is depicted graphically on that day. The member is free to accept or reject any proposed recipe, solicit an alternative proposal, or hand select and assign a recipe.

Once a meal plan 40 is accepted by the user, the system uses known serving and portion size information for the family/user along with dish recipe information 6 to generate a grocery list 42 of items required to execute the meal plan. The grocery list may be displayed in various formats including by time period or by recipe.

As an example, FIG. 7 is an exemplary screen print of a shopping list generated for one day, Thursday July 26. Ingredients to be purchased are sorted by food group, and the member is provided with a data entry window (top) for designating ingredients already in their possession versus those to be purchased. Alternatively, FIG. 8 is an exemplary screen print of a shopping list generated for one particular meal, scheduled to be served Thursday July 26. Ingredients to be purchased are sorted by recipe item (e.g., scrambled egg pasta) and again the member may designate ingredients already in their possession versus those to be purchased.

Applying detailed food item location information 43 for the user's selected store or stores, if available, the grocery list can be sorted and group by store and even aisle location within a store for each item. Alternately, a delivery order or other service (e.g., in-store order fulfillment for customer pick-up) from a grocer offering such service can be generated and placed automatically. In addition to the grocery list, a daily task list 41 is generated and appropriately timed reminders are provided to the user for food preparation steps such as thawing necessary ingredients prior to needing them for preparation of a scheduled dish. Task list reminders can be provided to users by email, text message or any other appropriate means as determined by user account and profile settings. As the meal plan is executed the system updates the family's personal meal history and solicits feedback on dish and meal likes and dislikes that are used to revise and inform the family's profile used for future meal planning. Meal feedback requests can be provided to each family member through emails, texts, online forms or other automated means.

Integration of the system with grocers and food manufacturers is an important aspect of the invention and enables many of the innovative features. In a preferred embodiment users may select one or more preferred stores/locations, or may be automatically associated with one or more preferred Stores/Locations for an in-network retailer or retailers based on geographical proximity. In-network retailers share product inventory, availability and price information on a location by location basis so as to enable the system to ensure ingredient availability and make accurate and real time cost analyses of a dish and/or meal in order to ensure that user cost criteria are met. Similarly, both grocers and manufacturers preferably share coupon or promotional information in order to maximize the effectiveness of the cost control component of the algorithm and also to provide the maximum benefit to grocers and food manufacturers seeking to promote their products.

### Meal Planning Algorithm and Data Model

The meal planning algorithm employs a system of required and permissive weightings to promote or demote dishes based on their recipes and preferences and other factors stipulated by the user. In order to apply the meal planning algorithm, recipes (and other objects) are provided with a plurality of data elements describing an attribute of the recipe or other object. Recipes also contain a number of data points set for the recipe as a whole. Recipe attributes describing the recipe or dish but not actually part of the recipe itself include:
Event/Holiday: the event or holiday with which a food is associated, i.e. Passover, Christmas, etc.
Season: the seasons with which a food is associated, i.e., fall, summer, etc.
Cuisine: Describes a food type, i.e., Thai, Italian, Creole, etc.
Main Ingredient: one or more characterizing ingredients, i.e., chicken (as in a chicken dish.)
Herbs/Spices: one or more characterizing herbs or spices, i.e., curry.
Heat: a relative indication of the spiciness of a dish, i.e., 1 Chili (mildly spicy) or 5 chilies (very spicy).
Flavor Intensity: describes the intensity of overall dish flavor (from bland to intense).
Meal: the meal or meals with which a dish is associated, most commonly dinner.
Meal Part: Main dish, side dish, etc. (also referred to as dish classification)
Dish Type: soup, stew, roast, etc.

Pyramid Part: indicates the part of the USDA food pyramid into which the dish primarily falls (fats, dairy, meat, etc.)
Nutritional Information: aggregate nutritional information for the dish, typically on a single serving basis (i.e., calories, fat, saturated fat, sodium, etc.)
Special Equipment: describes any special equipment required for the dish (i.e., crock pot, deep fryer, wok, etc.)
Budget: indicates the general budget category for a dish (i.e., budget, average/typical, luxury/gourmet, etc.)
Dietary Classification: vegan, vegetarian, Kosher; Halal, high-fiber, etc.
Restricted Ingredients: recites ingredients commonly restricted (i.e., nuts, wheat gluten, lactic acid etc.)
Degree of Difficulty (to prepare): easy, hard, etc.
Pairing Color: indicates colors that complement the color of this dish.
Pairing Texture: indicates textures that compliment the texture of this dish.

Recipe attributes describing the recipe itself that are intended to be displayed to the user include:
Title: the name of the dish.
Description: a description of the dish.
Warnings: warnings concerning the dish, such as warnings concerning consumption of raw eggs or undercooked meats, etc.
Yield: the expected number of servings or total quantity of the prepared dish.
Portion Size: the size of a single serving.
Scaling Instruction: instructions uniquely applicable to scaling the recipe.
Preparation and cooking times: the total time necessary for preparation, active time for preparation and pre-made preparation times.
Instructions: step by step instructions for preparation.
Ingredients: the list and quantity of ingredients, each a 4-tuple.

For any given object certain data elements will be required while others may be permissible but not required. Additionally, certain data elements will be singular, allowing only 1 value, while others may permit a limited or unlimited number of values. Certain data elements will be coupled together in a tuple to adequately describe the attribute of the object. For example, a recipe ingredient line may include a 4-tuple consisting of <quantity><measure><ingredient><instruction>, i.e., <½> <cup> <carrots> <finely chopped>. Certain other data elements require defined vocabulary data elements such as, for example, the “heat” data element describing the spiciness of a dish may have valid values of 1-chili through 5-chili.

Like the recipe itself, the user/family profile plays a large role in meal selection by the system. Each user or family may contain a list of uniquely identifiable family members and regular guests who each have a personal profile and whose preferences and requirements can be consolidated and accounted for meal planning purposes. Personal profile attributes include identifying information such as name, age and gender, but also information such as family relations (mother, father, etc.), household roles (all are diners, some are shoppers, planners or chefs), and work locations (useful for identifying alternate stores/locations for shopping). In addition to identifying information, each personal profile includes the planner preferences for the individual including:
Meal: the meal to which the preference applies (typically dinner).
Meal Composition: a preferred selection of meal parts, i.e., 1 entre, 2 sides, 1 dessert.
Pyramid Preferences: a preferred balance of USDA food pyramid elements.
Nutritional Information: Targets for specified nutritional elements.
Budget Preference: for an individual meal or overall meal plan.
Event/Holiday Preferences: events or holidays significant to the individual.
Seasonal Preferences: the level of preference the individual gives to seasonal dishes.
Product and brand Preferences: product and brand preferences are selected at meal planning time although they may be indicated here.
Rotations: how frequently a meal can be repeated.
Special Days: predefined days of the week (i.e. pot roast on Sundays, hot dogs on Thursday) or on special days (such as a favorite meal on a birthday, etc.).
Weekly Balance: a target nutritional balance across a meal plan, i.e. 1 red meat, 2 chicken, 7 vegetables, etc.

Other attributes associated with the personal profile are applicable to the individual's roles as grocery shopper, chef and, most importantly, as diner. Shopping preferences may include one or more preferred stores near a given location (such as work or home), a preferred number of trips to the store in a given period, and a convenience preference such as delivery service, distance to the store, etc. Chef preferences for the personal profile may include degree of difficulty, special equipment and maximum total or active preparation times. Diner preferences for the personal profile include:
Cuisine preferences: preferences for for/against a particular type of cuisine.
Recipe preference: a like or dislike of a particular recipe, often identified as feedback to a meal in which the recipe was served.
Ingredient preferences/herb and spice preferences: a like or dislike of a certain ingredient or seasoning.
Heat preferences: a like or dislike of spicy foods.
Dish type preferences: a like or dislike of a type of dish, i.e. a like of soup, a dislike of salad.
Dietary requirements: vegan, vegetarian, kosher, etc. Dietary requirements are not preferences and must be adhered to.
Dietary restrictions: Typically an allergy, like a requirement, a restriction is not a preference and must be adhered to.
Dietary preferences: like a dietary restriction but is not absolute.

The foregoing data elements may be weighted for that user's preferences or aversions with respect to the each data element. Preferences are specified as ranging from −1 (maximum dislike) to +1 (maximum like) where zero indicates no preference for or aversion to the attribute. Weights are typically described in 2-tuple format such as for example “potatoes[+0.76]” which indicates a relatively positive weighting for potatoes (an ingredient) or “soup[−0.68]” which indicates a relatively negative weighting for all soups (a dish type). A requirement that an item or characteristic always appear or restriction that an item or characteristic never appear can be indicated for certain items or characteristics. However, requiring or restricting a data element is not the same as setting a maximum weight for or against an item (e.g., +1 for maximum like). Requirements that an item or characteristic never appear in the meal plan (such as peanuts or shellfish if there is an allergic family member) are specifically set outside of the weighting scale and must be adhered to.

In a preferred embodiment, each meal in a given plan is initially set to a default meal profile which reflects the most common condition for the family for the above and other parameters in order to facilitate ease of plan creation. Dining plan creation the planner can elect to alter the meal profile on a meal by meal basis by selecting from a list of predetermined meal profile variants that reflect the family's lifestyle. For example, if the meal planner knows that a member of the family will be travelling for one or two meals, he or she may select a predetermined meal profile that reflects that condition. Such profiles are given easy to identify names such as “Mom is away,” “The Usual”, “Sunday Dinner”, or “Neighbors Over” to reflect the condition they represent, as seen in FIG. 4. A calendar is kept to reflect these upcoming conditions, and these alternate meal profiles automatically change the meal parameters for their respective meals. Inevitably, there will be instances where a custom meal profile is needed to reflect a meal profile that is expected but that will not likely to be repeated. In such a case a custom profile for a given meal can be created by choosing an existing meal profile that most closely resembles the desired profile and then customizing the parameters of the profile for the single meal for which it is needed. For example, the planner may select the expected diners, chef etc. which will invoke the various restrictions and preferences related to the relevant individuals.

User-history data is also considered. An exemplary listing of user-history data points (per recipe) includes the following;

Number of times this recipe has been eaten

Number of times this recipe has been suggested by the system and rejected by the user

Most recent date this recipe has been eaten

Most recent date this recipe has been suggested by the system and rejected by the user

User ratings for this recipe (user is prompted to rate recipes after they are eaten) and dates when these ratings were assigned.

With the foregoing data elements in place, the software engine is applied to generate a meal plan over the selected number of days in the plan to be generated (FIG. 5). A typical meal plan is directed toward daily dinners and runs for a single week thus covering seven meals although any duration maybe selected. As described above, as part of the meal selection process, and for each meal to be planned, the planner then determines the meal profile which reflects such elements as meal composition, the household at which the meal will be prepared, the diners (both family and guests) who will be present at the meal, the food shopper for the groceries needed to prepare the meal, the meal chef, and the budget target. The planner further establishes scorecard weighting for diner preference, shopper preferences, chef preferences and planner scoring components. The planner scoring components include pyramid score weighting, nutritional score weighting (at the dining party level), product preference weighting, brand preference score weighting and budgetary score weighting.

FIG. 9 is a high-level flow diagram of the meal selection plan algorithm 33 according to the present invention. The meal selection plan algorithm 33 inputs all member profile data points and user history data points, analyzes them in accordance with the Meal Planner schedule (FIG. 4) and recipe database and product database to select the set of candidate recipes from the recipe database that pass the absolute requirements and restrictions, best fit weighted requirements and restrictions, including cost constraints. The meal selection plan algorithm 33 matches dishes to users one at a time, while maintaining a history of meals within the recommendation set, in order to avoid duplications and mismatches. Individual matches of dishes to users is done using a weighted vector-similarity algorithm, with each facet representing a dimension in vector space, and the importance (weighting) of the dimension determined by user profile characteristics. As indicated above, some constraints may be marked as ‘hard’ so that recipes violating that constraint are never returned to the member even though overall similarity may be high.

Note: when sales on inventory items come into effect, information on cost savings needs to be added to recipes that contain the sale product or a parent ingredient of the product. However, this cost savings should only be applied in cases where ingredients for the recipe are to be purchased at the store(s) where the sale is in effect. To handle this, the recipe database may temporarily create store-specific versions of recipes in the database. Likewise, when sales expire, store-specific recipes need to be removed. This may entail the reverse of the above. Consequently, the meal selection plan algorithm 33 is able to perform matches against both permanent recipes and store-specific recipes. Store-specific recipes are filtered out with a hard constraint when the user has not indicated they will be shopping at a particular store associated with a store specific recipe.

The meal selection plan algorithm 33 applies the weighted vector-similarity algorithm, with each data element representing a dimension in vector space, and weighted according to the assigned required and permissive weightings (to promote or demote dishes based on their recipes, preferences, cost, and other factors stipulated by the user), the meal selection is undertaken to select the set of candidate recipes from the recipe database that pass the absolute requirements and restrictions. Absolute requirements and restrictions include satisfaction of all dietary requirements, no violations of dietary restrictions, that the recipe is supported by available inventory, equipment in the home, time available for preparation is satisfied, and serving sizes are correct. For each recipe in the candidate set, a contextual baseline score is determined. All contextual baseline scores start at zero and are adjusted by Seasonality/Holidays (+/−), recipes that take advantage of grocer or manufacturer specials and promotions (+), rotations (recipe, cuisine and heat) (+/−), Queued recipes and favorites (+). Candidate recipes are then scored for the planner, taking into account the pyramid score (for the family), nutritional score (for the family), dietary preferences score (for the family), product preference scores, brand preference scores, and budgetary scores.

After planner preferences are accounted for, recipes are scored for shopper preferences (store convenience) and chef preferences (degree of difficulty, requisite equipment). Lastly, candidate recipes are scored for each diner based on dietary preference score, cuisine preference score, recipe preference score, ingredient preference score, herb/spice preference score, heat preference score and dish type preference score. Once scored on all factors as recited the candidate recipes are ranked in order and top scoring main dishes/entrees are assigned to an appropriate open meal slot in the plan. After all open slots are assigned a main dish, side dishes are selected and paired with the main dish to complete a meal through a similar scoring process. Particular attention is paid to color, texture, cuisine, heat, food pyramid, nutritional and compositional factors when selecting side dishes. After each meal is completed an aggregate score is computed for each meal and for the entire meal plan to enable comparison by substitution during the meal plan editing and acceptance process.

As described above, after the user has accepted a meal plan the system automatically generates corresponding ingredient listings, recipes and preparation instructions for each meal and time to cook, as well as daily task lists (e.g., take the chicken breasts out of the freezer). Moreover, the system compiles a shopping list for the ingredient listings sorted by store and by aisle, or if preferred, automatically generates and transmits a delivery/service order to the appropriate store(s). The shopping list includes how much to buy, where to buy, and sale prices and promotions. Where local or manufacturer coupons are available for those stores or products, bar-coded cutout coupons are printed directly with the shopping list.

Alter meal consumption the system solicits feedback on each prior-night's meal. This history and feedback is maintained and becomes a key driver for subsequent meal plans. Over time, the system learns new and/or changed user-preferences and ascertains patterns, becoming smarter from the daily feedback.

It should now be apparent that the above-described integrated system and method provides a turn-key solution for developing customized and individualized meal plans tailored to meet the specific needs of the family taking into account: 1) preferences of the individual family members including budgetary considerations as well as nutritional goals and requirements; 2) food product cost and inventory/availability information including local grocery store sales, promotions and coupons as well as manufacturer coupons; and 3) paid sponsor support and advertising. Its generation of not only of weekly meal plans, but also of detailed ingredient lists, recipes and instructions, food shopping list by store and aisle by aisle, greatly facilitates meal planning and food shopping and will promote adherence to a healthier, more economical and socially acceptable at-home family meal plan rather than a fast-food lifestyle.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

What is claimed:

1. A system of planning and managing familial meal preparation by a user, the system comprising:
at least one computer processor;
at least one memory having instructions which configure the at least one computer processor to:
store user data in a database, the user data including at least a nutritional target for a meal, a budget for said meal, a number of servings to be prepared for said meal and a time available for preparation of said meal, said user data further associated with at least one profile of an individual, said at least one profile including at least one food preference;
store recipe data in a database, the recipe data including at least a preparation time, a default number of servings and a quantified list of ingredients for a plurality of dishes;
store product data in a database, the product data including at least an ingredient for which the product may be used and nutritional information regarding said product;
store inventory data in a database, the inventory data including a store identifier, the product to which the inventory data relates, a base price for the product and the period for which said base price is valid at said store;
receive from said user a request for at least one meal proposal, said request identifying the profiles of the individuals expected to be present at said meal;
determine, from said database, the products required to prepare said plurality of dishes, the cost to purchase said required products at said base price, a total base cost to prepare said dish and a nutritional profile for said dish;
rate each of said plurality of dishes based on the one or more food preferences of the profiles of each of said individual expected to be present at said meal;
select from said plurality of dishes one or more selected dishes comprising one or more proposed meals in which the total cost to prepare said selected dishes of each proposed meal is less than said budget for said meal, said nutritional profiles of said selected dishes of each proposed meal collectively meet or exceed said nutritional target, the aggregate preparation time of said selected dishes of each proposed meal does not exceed said time available for preparation of said meal and the rating of said one or more selected dishes of each proposed meal exceeds a threshold value; and
transmit for display to and confirmation by the user the one or more selected dishes for the one or more proposed meals.

2. The system of claim 1 wherein said profiles further include any food allergen of the individual associated with said profile and wherein said instructions further configure the at least one computer processor to:
preclude from selection all dishes for which the recipe includes as an ingredient at least one food allergen included in the profile of any individual expected to be present at said meal.

3. The system of claim 1 wherein said profiles further include one or more food aversions of the individual associated with said profile and wherein said instructions further configure the at least one computer processor to:
rate said plurality of dishes based on both the one or more food preferences and the one or more food aversions of the profiles of each of said individual expected to be present at said meal.

4. The system of claim 1 wherein said at least one food preference is selected from the group consisting of a preferred cuisine, a preferred ingredient and a preferred dish type.

5. The system of claim 1 wherein said inventory data further comprises a sale price and a period for which said sale price is valid at said store for one or more products and wherein said instructions further configure the at least one computer processor to:
create store specific recipe data in said database for each dish for which the list of ingredients includes an ingredient for which a product having a related sales price may be used, said store specific recipe data including at least a preparation time, a default number of servings and a quantified list of ingredients.

6. The system of claim 5 wherein said user data includes a preference for taking advantage of sales and wherein said instructions further configure the at least one computer processor to:
determine, from said database, the cost to purchase said required products at said sale price and a total sale cost to prepare said dish; and to
rate said plurality of dishes based on a comparison of the sale cost to prepare a given dish with the base price to prepare said given dish.

7. The system of claim 1 wherein the recipe data further categorize a dish as a single-dish meal, a main dish or a side dish, and wherein said instructions further configure the at least one computer processor to:
determine a number and categorical makeup of dishes for each of the at least one requested meal proposals; and, when selecting from said plurality of dishes one or more selected dishes comprising one or more proposed meals, to
if the number of dishes determined for a proposed meal is one, select a single-dish meal, and
if the number of dishes determined for a proposed meal is greater than one, select first a main dish and then select a number of side dishes that is one less than the number of dishes determined for a proposed meal, the side dishes selected to be compatible with the ingredients, taste and color of said selected main dish.

8. The system of claim 1 wherein said instructions further configure the at least one computer processor to receive from one or more of said individuals expected to be present at a given meal feedback as to their likes or dislikes with respect to each dish confirmed to be served at said given meal;
to store said received feedback in said user data of said database; and, when rating said plurality of dishes,
to modify a rating of a dish based on said feedback.

9. The system of claim 8 wherein said instructions further configure the at least one computer processor to compare the user data of said user with corresponding data stored with respect to other users, and when rating said plurality of dishes, to modify a rating of a dish based on said corresponding data stored with respect to other users.

10. The system of claim 1 wherein said user data further comprises the number of times a given dish has been previously confirmation by the user for a proposed meal and the date on which the dish was last confirmed, and wherein said instructions further configure the at least one computer processor, when rating said plurality of dishes, to modify a rating of a dish based on the number of times a given dish has been confirmed and the length of time since said dish was last confirmed.

11. The system of claim 1 wherein said user data further comprises the number of times a given dish has been proposed for a given meal but not confirmed by the user and the date on which the dish was last proposed and not confirmed, and wherein said instructions further configure the at least one computer processor, when rating said plurality of dishes, to modify a rating of a dish based on the number of times a given dish has been proposed and not confirmed and the length of time since said dish was last proposed and not confirmed.

12. The system of claim 1 wherein said instructions further configure the at least one computer processor to:
generate a list of products required to be purchased from a store to prepare the one or more selected dishes for the one or more proposed meals, and
transmit said list for fulfillment.

13. The system of claim 11 wherein said list is transmitted to said user for fulfillment in a retail store.

14. The system of claim 11 wherein said list is transmitted to a store for automatic fulfillment.

15. The system of claim 1 wherein said threshold value is the rating of the second highest rated dish of said plurality of dishes.

16. A computer implemented method of planning and managing familial meal preparation by a user, the method comprising the steps of:
storing user data in a database resident on a web-enabled computer server, the user data including at least a nutritional target for a meal, a budget for said meal, a number of servings to be prepared for said meal and a time available for preparation of said meal, said user data further associated with at least one profile of an individual, said at least one profile including at least one food preference;
storing recipe data in a database resident on a web-enabled computer server, the recipe data including at least a preparation time, a default number of servings and a quantified list of ingredients for a plurality of dishes;
storing product data in a database resident on a web-enabled computer server, the product data including at least an ingredient for which the product may be used and nutritional information regarding said product;
storing inventory data in a database resident on a web-enabled computer server, the inventory data including a store identifier, the product to which the inventory data relates, abase price for the product and the period for which said base price is valid at said store;
receiving, by the web-enabled computer server, a request for at least one meal proposal, said request identifying the profiles of the individuals expected to be present at said meal;
determining, by the web-enabled computer server, the products required to prepare said plurality of dishes, the cost to purchase said required products at said base price, a total base cost to prepare said dish and a nutritional profile for said dish;
rating, by the web-enabled computer server, each of said plurality of dishes based on the one or more food preferences of the profiles of each of said individual expected to be present at said meal;
selecting, by the web-enabled computer server, from said plurality of dishes one or more selected dishes comprising one or more proposed meals in which the total cost to prepare said selected dishes of each proposed meal is less than said budget for said meal, said nutritional profiles of said selected dishes of each proposed meal collectively meet or exceed said nutritional target, the aggregate preparation time of said selected dishes of each proposed meal does not exceed said time available for preparation of said meal and the rating of said one or more selected dishes of each proposed meal exceeds a threshold value; and
transmit, for display to and confirmation by the user the one or more selected dishes for the one or more proposed meals.

17. The method of claim 16 wherein said profiles further include any food allergen of the individual associated with said profile and wherein said selecting step further comprising the substep of precluding from selection all dishes for which the recipe includes as an ingredient at least one food allergen included in the profile of any individual expected to be present at said meal.

18. The method of claim 16 wherein said profiles further include one or more food aversions of the individual associated with said profile and wherein said rating step further comprises rating said plurality of dishes based on both the one or more food preferences and the one or more food aversions of the profiles of each of said individual expected to be present at said meal.

19. The method of claim 16 wherein said inventory data further comprises a sale price and a period for which said sale price is valid at said store for one or more products, said method further comprising the step of
creating store specific recipe data in said database for each dish for which the list of ingredients includes an ingredient for which a product having a related sales price may be used, said store specific recipe data including at least a preparation time, a default number of servings and a quantified list of ingredients.

20. The method of claim 16 wherein the recipe data further categorize a dish as a single-dish meal, a main dish or a side dish said method further comprising the step of:
determining a number and categorical makeup of dishes for each of the at least one requested meal proposals;
said selecting step further comprising the substeps of
selecting a single-dish meal if the number of dishes determined for a proposed meal is one, and
select first a main dish and then select a number of side dishes that is one less than the number of dishes determined for a proposed meal if the number of dishes determined for a proposed meal is greater than one, the side dishes selected to be compatible with the ingredients, taste and color of said selected main dish.

21. The method of claim 16 further comprising the step of
receiving from one or more of said individuals expected to be present at a given meal feedback as to their likes or dislikes with respect to each dish confirmed to be served at said given meal;
storing said received feedback in said user data of said database; and,
modifying a rating of a dish based on said feedback.

22. The method of claim 16 wherein said user data further comprises the number of times a given dish has been previously confirmation by the user for a proposed meal and the date on which the dish was last confirmed, wherein said rating step further comprises modifying a rating of a dish based on the number of times a given dish has been confirmed and the length of time since said dish was last confirmed.

23. The method of claim 16 wherein said user data further comprises the number of times a given dish has been proposed for a given meal but not confirmed by the user and the date on which the dish was last proposed and not confirmed, and wherein said instructions further configure the at least one computer processor, wherein said rating step further comprises modifying a rating of a dish based on the number of times a given dish has been proposed and not confirmed and the length of time since said dish was last proposed and not confirmed.

24. The method of claim 16 wherein further comprising the steps of
generating a list of products required to be purchased from a store to prepare die one or more selected dishes for the one or more proposed meals, and
transmitting said list for fulfillment.
